(19) United States
(12) Patent Application Publication
(10) Pub. No.: US 2011/0030059 A1
(43) Pub. Date: Feb. 3, 2011

(54) Method for testing the security posture of a system

(76) Inventor: Lloyd G. Greenwald, Murray Hill, NJ (US)

Correspondence Address: Alcatel Lucent;Docket Administrator (Room 2F-192), 600 Mountain Avenue, Murray Hill, NJ, 07974-0636, US

(21) Appl. No.: 12/462,148

(22) Filed: Jul. 30, 2009

(51) Int. Cl. G06F 11/00; G06F 15/18

(52) U.S. Cl. 726/25

(57) ABSTRACT

A method is provided for assessing the susceptibility of a NIDS to evasion. In an embodiment, the method involves intercepting packets that pass through a NIDS or other defensive device, reading, from the intercepted packets, message sequences that pertain to at least one protocol or network application, and constructing at least one stochastic sequential model of usage of the protocol from the protocol sequences.

### FIELD OF THE INVENTION

The invention relates to methods for enhancing security in computer networks, and more particularly to intrusion detection in IP networks.

### ART BACKGROUND

It is well known that networked computers are susceptible to malicious attacks of various kinds, in which, for example, a denial-of-service attacker uses packet traffic to overwhelm the targeted system's ability to respond to legitimate communication requests, or an intruder attempts to gain unauthorized access to the target computer.

Several measures are available for defending networks against packet-based attacks. For example, a Network Intrusion Detection System (NIDS) monitors incoming packets for suspect patterns that might indicate malicious activity. Typically, a NIDS is deployed as an independent platform situated at a network border or connected to a hub or network switch.

A typical NIDS device may have its own vulnerabilities that make it susceptible to evasion by determined attackers. For example, in a so-called “insertion attack”, the attacker discovers packets that are accepted by the NIDS even though they are rejected by the protected end-system, and exploits this disparity to conceal the collective pattern of attack packets.

Experts in network security have developed methods for assessing the susceptibility of a NIDS to evasion. Some of these methods require detailed knowledge of protocol semantics and as currently applied may require manual ad hoc processes. Other processes rely on fuzzing, i.e., on the more-or-less random generation of program inputs, which are fed to an application in the hope of provoking a crash or other evidence of a vulnerability. However, there remains a need for new approaches that can be automated, have broad applications, and can be made more efficient than approaches based on random fuzzing.

### SUMMARY OF THE INVENTION

We have developed such an approach. In one embodiment, our approach involves intercepting packets that pass through a NIDS or other defensive device, reading, from the intercepted packets, message sequences that pertain to at least one protocol or network application, and constructing at least one stochastic sequential model of usage of the protocol from the protocol sequences.

In some implementations, the stochastic sequential usage model is, used to provide one or more protocol sequences that will pass through the defensive device.

In some implementations, queries are made that specify probabilities for protocol sequences, or that specify sub-sequences that should be included in a protocol sequence, or both, and the protocol sequences are provided in response to the queries.

In some implementations, the stochastic sequential usage model is applicable to the defensive device that protects a network, and packets that relate to the provided protocol sequences, or portions thereof, are transmitted through the defensive device into the protected network.

In some implementations, the protected network is monitored to detect whether the transmitted packets induce a security incident.

In some implementations, one or more security incidents are identified by the transmitted packets; and the defensive device protecting the network is modified to recognize one or more sequences of the transmitted packets that have been identified as inducing security incidents.

### BRIEF DESCRIPTION OF THE DRAWING

FIG. 1 is a schematic diagram of an illustrative network, showing possible paths for packet-based attacks.

FIG. 2 is a block diagram of an implementation of the invention.

FIG. 3 is an example of a state diagram, based on a known NIDS.

FIG. 4 is an example of the messages exchanged and the states involved in an SMTP session.

FIG. 5 is a collection of three observed traces of SMTP sessions.

FIG. 6 is a graph summarizing all of the state transitions observed in FIG. 5. Transition probabilities on each edge of the graph have been omitted. If they were included, FIG. 6 would be an example of a graphical representation of a sequential stochastic model.

FIG. 7 is an example of the messages exchanged and the states involved in an SMTP session in which the client issues multiple AUTH commands. The state transitions are as summarized in FIG. 6.

FIG. 8 is an example of the messages exchanged and the states involved in an SMTP session in which an attacker attempts to exploit the TLS feature of SMTP.

FIG. 9 is an illustrative example of a 2-Markov model, in graphical representation.

### DETAILED DESCRIPTION

Our approach may be implemented in any of various defensive devices, including without limitation NIDS devices, firewalls, other intrusion prevention devices, and application firewalls. Implementations may be in either hardware-based or software-based devices.

For example, a host-based intrusion detection system (HIDS) runs on an end-user commodity computer or server such as a Windows or Linux-based PC.

A NIDS device, in particular, may be implemented on stand-alone hardware or on a commodity computer. Standalone hardware typically has better performance and for that reason is generally preferred in environments with fast line speeds or significant traffic. A commodity computer with, for example, the Linux OS and a software-based NIDS such as Bro can be used in a less taxing environment.

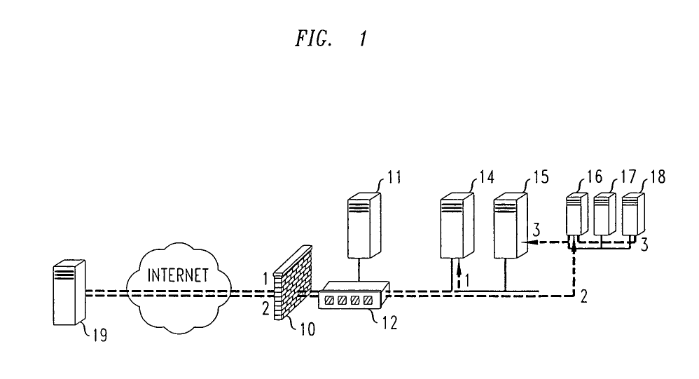

As shown in FIG. 1, the NIDS may run inside a firewall and be implemented in software on a commodity machine connected to a network tap. Alternatively, the NIDS might reside outside the firewall in a demilitarized zone (DMZ). It could also reside inside an ISP's network. Instead of a commodity machine connected to a network tap, the NIDS could be implemented on a router or switch directly in-line with the network traffic. The NIDS could also be part of the firewall itself and be implemented on the same hardware.

For simplicity, we will refer below to a NIDS as a representative defensive device. However, it should be borne in mind that our approach is not limited to NIDS implementations, but instead is applicable to any of various defensive devices, including those listed above.

According to our approach, we envisage a NIDS as a black box, i.e., we make few or no a priori assumptions about its design and implementation. Based on the message sequences that are observed to pass through the NIDS, we create a model of what sequences the NIDS deems to be innocuous. Typical sequences for this purpose are protocol sequences or sub-sequences in whole or in part, and other message sequences that pertain to protocols or applications. The models can then be used to create new sequences that may include embedded attacks.

One particular class of vulnerabilities amenable to discovery using this approach is a consequence of ambiguities in protocol specifications. That is, many protocols are specified with enough ambiguity for their implementers to exercise individual discretion in how to optimize the implementations, how to set initial parameters, whether or not to include optional features, etc. Consequently, a NIDS is advantageously designed to permit traffic from multiple implementations of the same protocol. Thus when a mail server, for example, is exchanging messages with other mail servers, a NIDS monitoring SMTP traffic is preferably designed to allow valid exchanges to proceed, regardless of the SMTP implementations of the end-point mail servers.

A possible consequence is that a NIDS may interpret a protocol in a manner that differs from any specific implementation. For example, a particular sequence of commands might cause a NIDS to enter one state, whereas the same command sequence causes the target server to enter a different state. In such a situation, the NIDS might fail to detect an attack sequence such as (in case of SMTP command sequences) an attack on a mail server.

Moreover, if a NIDS permits traffic from multiple implementations of the same protocol, then it might also permit traffic in which packets embodying multiple protocol implementations are interspersed. Such interspersed traffic might have unanticipated effects on the target system.

By applying our approach, we can generate low-probability sequences and interspersed sequences that may evade the NIDS defenses and thus pose potential threats to the protected networks. Once such sequences are discovered, defensive systems can be modified to defend against them.

One type of model useful in this regard is a Stochastic Sequential Model (SSM). A SSM can be represented as a finite state machine, in which a probability is specified for each state transition, and future states depend only on the present state and the corresponding transition probabilities. The “present state” may take into account a memory of the most recent two, three, or more most recently past states.

The herein-named inventor has previously described the use of SSMs in modeling the usage of a protocol, for example to determine whether a malicious intruder is trying to abuse the implementation of the protocol as embodied, typically, in server software. In that reported work, models were built from network traffic irrespective of defensive devices, and the models were queried for incongruities in the protocol implementations, in order to suggest improvements in the protocol implementations. In this regard, reference is usefully made to L. Greenwald, “Learning Sequential Models for Detecting Anomalous Protocol Usage,” Proc. of the Workshop on Machine Learning Algorithms for Surveillance and Event Detection, 23^{rd} Int. Conf. on Machine Learning, Pittsburgh, Pa. (2006).

The herein-named inventor has also previously described the use of SSMs to build models of a Web application from logged user data. In this regard, reference is usefully made to J. Sant, A. Souter, and L. Greenwald, “An Exploration of Statistical Models for Automated Test Case Generation,” Proc. of the 3d Int. Workshop on Dynamic Analysis, Int. Conf. on Software Eng., St. Louis, Mo., published by ACM, New York (2005).

A typical network environment in which a NIDS is deployed is illustrated in FIG. 1. Reference to the figure will show a subnetwork deployed behind firewall 10, in which NIDS 11 monitors the subnetwork via tap 12, and in which the subnetwork includes servers 14 and 15, and virtual machines 16-18. (Although shown separately for convenience, the three virtual machines in this example are actually deployed within server 15 as the host.)

Three paths are illustrated in the figure for attacks launched from remote system 19: On path 1, the intruder attempts to evade the NIDS and remotely attack a server vulnerability; on path 2, the intruder attempts to evade the NIDS and remotely attack a virtual machine vulnerability; on path 3, the intruder attempts to evade weak virtual network defenses and attack a virtual or host machine vulnerability.

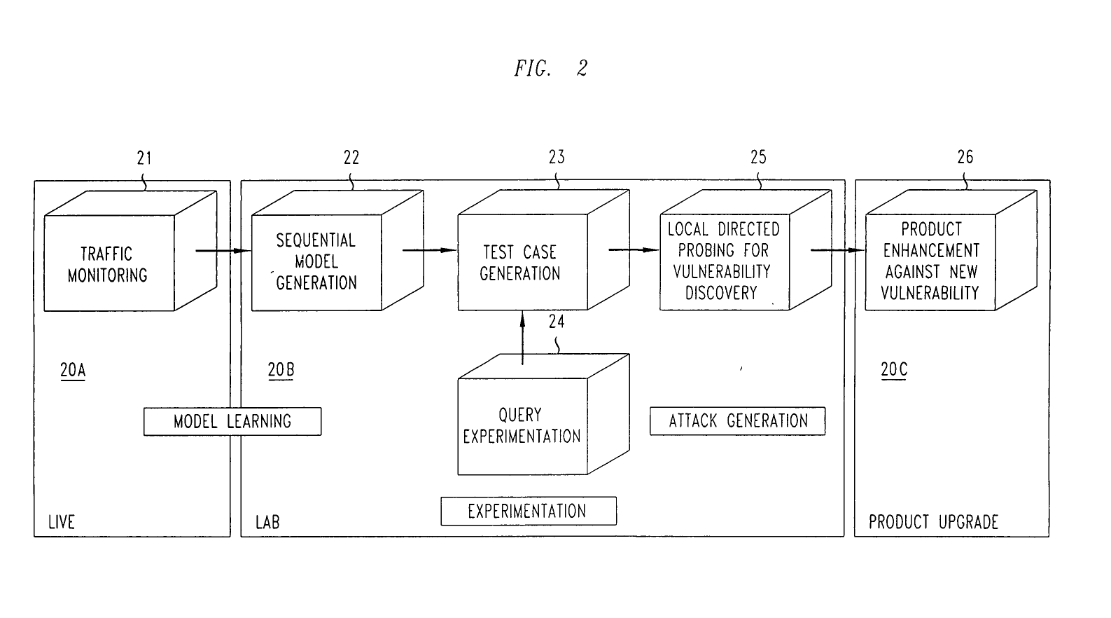

With reference to FIG. 2, an implementation of our new approach includes live, i.e., real-time, phase 20A, laboratory phase 20B, and product enhancement phase 20C. In phase 20A, as indicated at block 21 of the figure, live traffic behind a NIDS or within a virtual network is collected. The collected traffic represents the types of message sequences that the NIDS or virtual network considers to be innocuous. For example, traces of normal SMTP sessions could be collected in this phase.

In phase 20B, as indicated at block 22 of the figure, sequential stochastic models (SSMs) are constructed, that capture the collected message sequences. That is, a finite number of states is enumerated for the modeled system, among which the various state transitions are associated with the input, or output, or both, of identified message sequences. Each state transition may further be associated with a probability.

The SSMs are then used to generate (block 23) new message sequences that follow the same patterns as the collected sequences, but that may be unusual in some respect. For example, sequences may be generated in the laboratory that are unlikely to have been previously tested by a particular protocol implementation that is under study, such as a particular SMTP implementation. Block 24 of the figure represents the queries that may be directed to the SSM, specifying desired characteristics for the generated sequences. As indicated at block 25 of the figure, these new sequences may then be tested on a representative system, such as an email server, serving as an experimental subject in the laboratory. Given a sufficient number of such test sequences, we believe it likely that latent bugs in, e.g., the server implementation will lead to a server failure.

In phase 20C, as indicated at block 26 of the figure, the NIDS or virtual network defense is updated to remove the vulnerabilities that have been discovered.

By “innocuous” sequence of packets, we mean a sequence of packets that a NIDS will accept without triggering an alert. A goal of the operations represented by block 23 of FIG. 2 is to find sequences of packets that a NIDS will believe are innocuous sequence, yet will exercise vulnerabilities within the target networking software or application. Such a sequence of commands is referred to as a “network mimicry attack.”

Our approach exploits the possibility that a NIDS may be designed based on a protocol, not any specific software implementation of the protocol. Thus, there may be sequences that are innocuous for a protocol but not tested for a specific implementation of that protocol. For example, a sequence of commands to an SMTP server might exercise a latent bug in that server implementation without being detected by the NIDS.

In summary, we look at a NIDS as a black box and model what a NIDS considers innocuous sequences based on the sequences that pass through the NIDS. These models can then be used to create new sequences that may include embedded attacks. For example, we can generate sequences in the lab that are unlikely to have been tested by a target SMTP implementation. The proposed system then tests these sequences on an email server in the lab. Given enough test sequences, we expect to find a sequence that will lead to a server failure, if the server implementation contains any latent bugs.

### Example Network Mimicry Attacks

We now describe two examples of mimicry attacks against an email system using Simple Mail Transfer Protocol (SMTP). In the first example, we find a sequence of commands that exercise a latent bug in the server without being detected by the NIDS. In the second example, we find a sequence of commands that causes the NIDS to enter the incorrect state such that it does not detect an attack email that it otherwise would detect.

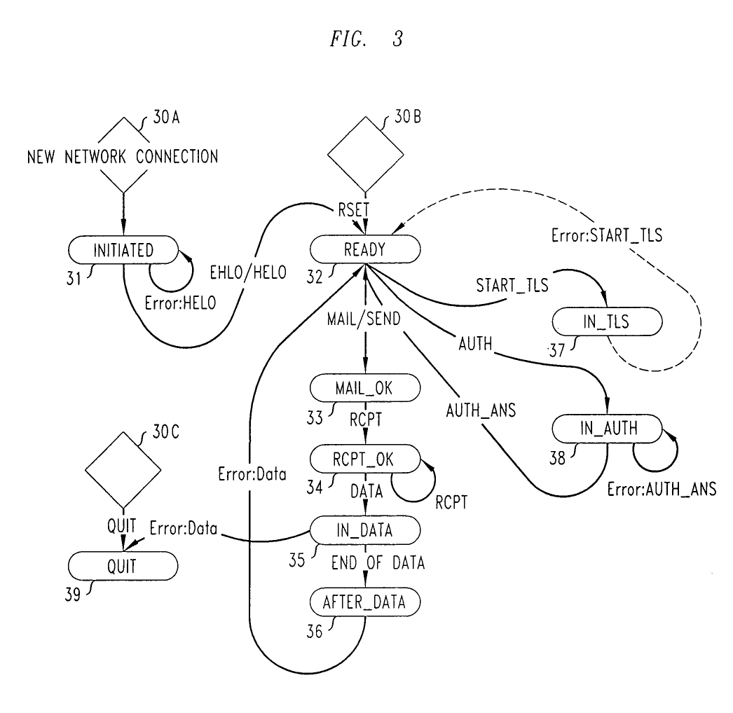

Both examples use a state machine of the SMTP protocol to model the NIDS and server behaviors. FIG. 3 shows the particular state machine, which was derived from a real NIDS system, Bro NIDS. Bro provides an open-source, Unix-based NIDS that passively monitors network traffic for activity indicative of an attack, or other unusual behavior.

The model uses a state transition diagram with command/response pairs as state transitions. Each state is given by an oval 31-39. After a client connects from a remote host, the model starts in the INITIATED state 31. The arrows represent the state transitions (edges). Most state transitions are given by a command and sometimes a response code (e.g., an error response). A few transitions (e.g., HELO/EHLO) result from multiple possible commands (i.e., HELO or EHLO). Diamonds 30A-30C in the diagram indicate transitions from any previous state. There is one broken line. It indicates a transition that appears in the SMTP protocol specification, but seems to be absent in Bro's model. The second example exploits this issue.

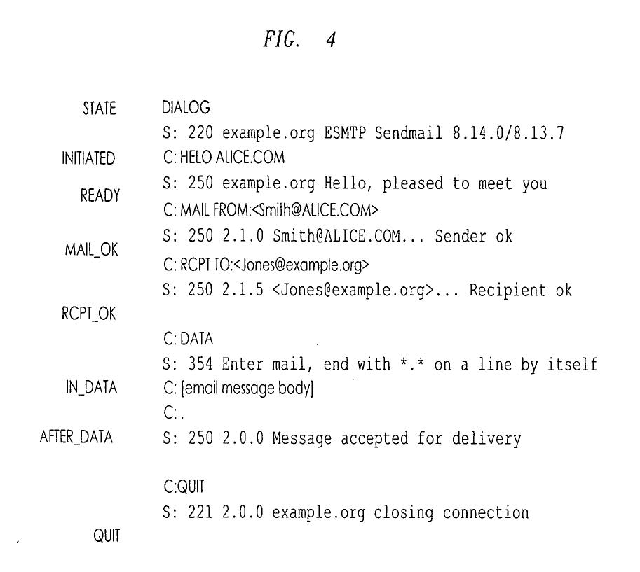

FIG. 4 shows a dialog from a sample SMTP session. The figure prefixes each line in the dialog with an S: or C: for the server and client, respectively. The left column shows the state, as defined in FIG. 3.

The first example mimicry attack against an email server is intended to demonstrate that the methods proposed in this work can be used to construct a sequence of commands that the NIDS will believe is an innocuous sequence and that will exercise a vulnerability within the email server. The example uses the same set of states as in FIG. 3 to represent each command/response pair in the command sequence.

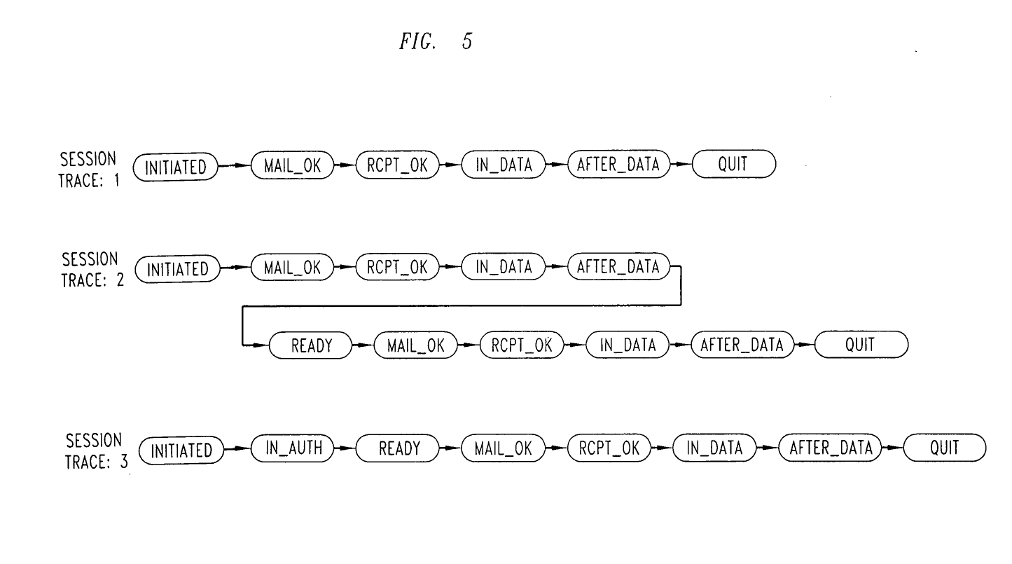

The first step is to collect SMTP sessions in the live network. FIG. 5 shows the sequences from three sessions. The first session trace uses the same sequence of commands as FIG. 4. By assumption, all such sequences are legal transactions that the NIDS system does not detect (in principle, one could verify this by checking the NIDS logs).

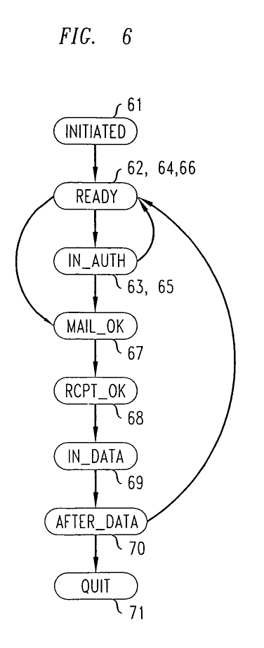

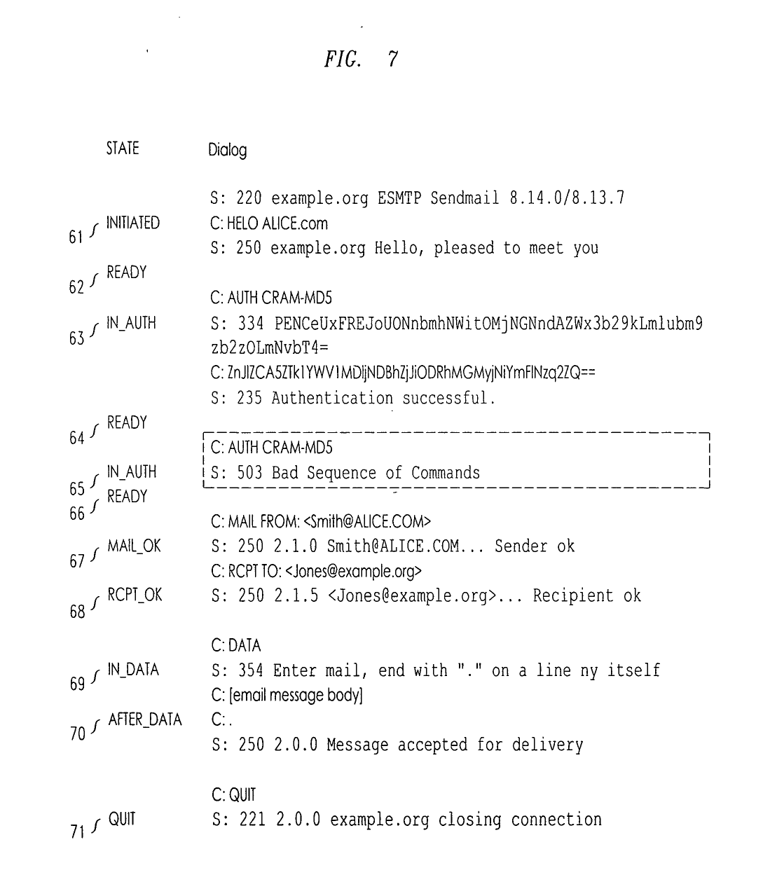

Next, we develop a graph connecting all the observed state transitions, as shown in FIG. 6. (Although a complete graphical representation of a sequential stochastic model would include a transition probability on each edge of the graph in FIG. 6, we have here omitted the transition probabilities to simplify the presentation.) To show the correspondence between FIGS. 6 and 7, common reference numerals 61-71 have been used to identify corresponding states.

Every walk through the graph shown in FIG. 6 will obtain a particular sequence of states representing a presumably legal sequence of commands. Each “walk” consists of a sequence of states that is traversed by selecting, from each current state (which may be thought of as a node of the graph) an edge that will lead back into the same node, or will lead to a different node of the graph (i.e., to a new state). Each edge corresponds to a particular state transition. In the course of a walk through the graph, each new transition—and hence the corresponding edge—is selected while in a given state by giving a command that, when starting from the given state, will elicit that particular transition. A walk is “random” if the state transitions are selected by a random process.

The system then tests random walks through the graph on an email server in the laboratory. Given enough test sequences and a server implementation containing latent bugs, we expect that at least one of the sequences will lead to a server failure.

In this example, we assume that the server implementation has a bug in the code that handles multiple AUTH commands. The SMTP protocol specification (RFC 2554) states that a session should only include a single AUTH command and that the server should reject any subsequent AUTH commands with a particular error message (a 503 error reply).

Since such a sequence is very unlikely to be seen in practice, however, it is a reasonable expectation that the code developer failed to anticipate this sequence and to test for it.

FIG. 7 shows the expected dialog for a session where the client issues multiple AUTH commands.

The repeated AUTH commands in this dialog elicit the error messages shown in the figure in association with the transition between states 65 and 66.

Suppose that after testing a case with multiple AUTH commands, the server fails due to the latent bug. One could imagine that there is a buffer overflow associated with the bug, which an expert could use to insert code into a specially crafted command. (The details of how the vulnerability is exploited are not essential to the present discussion.) What has been demonstrated is that the system may find a previously unknown bug in the server that can be exploited without being detected by the stateful NIDS.

Our second example shows a different type of mimicry attack. It differs from the previous one because it exploits a flaw in the NIDS rather than in the email server itself. As before, the example uses Bro's state model for SMTP. We assume that the attack traffic is inside the body of the email message (e.g., an email virus) and that the NIDS has a signature for the virus. We assume that the NIDS looks for the attack signature inside the body of the email message. Thus, for the NIDS to detect the attack traffic, the NIDS must be in the correct state (i.e., the IN_DATA state) when the traffic passes through it. If, on the other hand, the mimicry attack generates a legal sequence of messages that (a) the email server processes correctly and (b) causes the NIDS to enter the incorrect state, the attack payload would go through the NIDS without setting off an alarm. A local testbed with the NIDS system can be used to test command sequences instead of a live system.

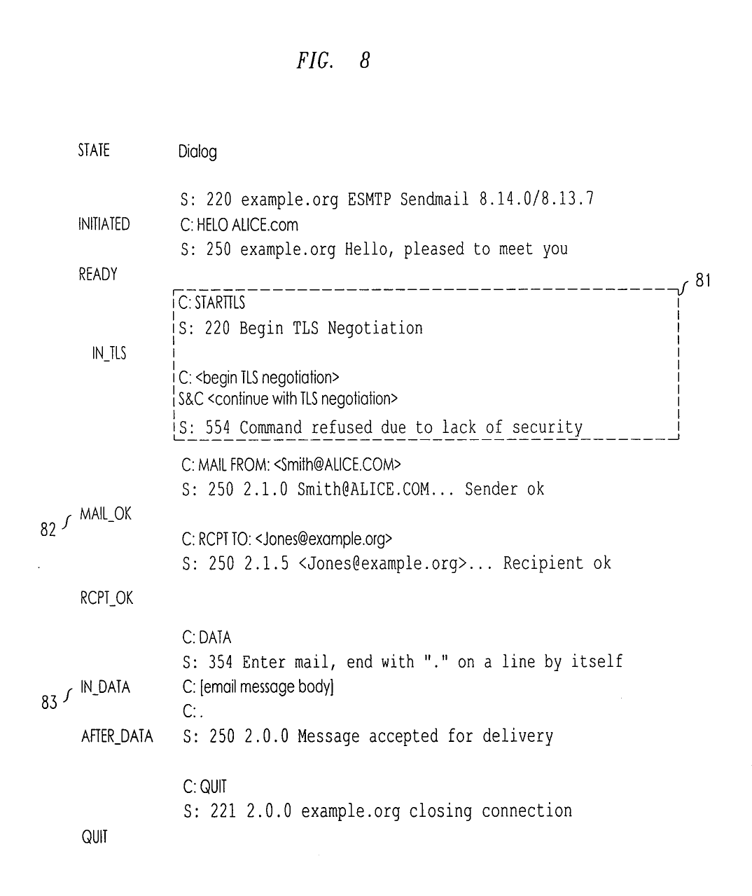

FIG. 8 shows a dialog similar to that of FIG. 4. This dialog includes an attempt 81 to use SMTP's Translation Layer Security (TLS) feature. The protocol specification (RFC 2487) allows the server to refuse to accept a TLS handshake for various reasons. One such reason is that the server considers the client's encryption algorithm or key length to be too weak. The example assumes that the server refuses to accept the TLS connection for one such reason. After the server rejects the TLS session, the client may continue with the unencrypted dialog, as before.

For this dialog, the simple NIDS state machine assumes that the TLS connection succeeds. Because the content would be encrypted in a TLS session, the NIDS, by assumption, does not process the rest of the content, as it does in the IN_DATA state. Thus, the NIDS remains in the IN_TLS state while the server goes on processing through MAIL_OK state 82. At IN_DATA state 83, the NIDS fails to detect the Virus embedded in the email message, because it thinks it is still in the IN_TLS state.

The example shows that it is possible to send a legal sequence of messages to the SMTP server that allows an attacker to transmit an attack message through the NIDS to the SMTP server. Because of the NIDS's state machine implementation, the NIDS would not flag an alert on the traffic, although a different implementation might detect the attack traffic. The first example given above is of the type of mimicry attack that can be found by an automated approach that does not require knowledge of the NIDS or protocol semantics. The second example might require deeper knowledge of the NIDS and protocol.

### Learning Stochastic Sequential Models

As noted above, J. Sant et al. (2005) have described the use of Stochastic Sequential Models (SSMs) to build models of a Web application from logged user data. The methods described there, and others, can be used to build sequential models of protocol usage from live traffic collected behind a NIDS, and in particular to isolate sequences that represent uncommon but legal usage.

A learned sequential model captures a probability distribution over recent protocol usage patterns. This black-box approach makes use of passively captured network traffic data and neither requires source code nor detailed knowledge of protocol specifications. By building models based on recent traffic collected behind a NIDS, the practitioner can develop tractable analysis methods to uncover potential vulnerabilities. This data-driven approach avoids requiring the potentially intractable analysis of all possible implementations of an ambiguous protocol specification.

One goal is to build sequential models that ensure that message sequences generated from these models will not cause an alert in an anomaly-based NIDS and ensure that the parameters in message sequences are contextually dependent on previous messages and consistent with previous legal parameters so that they will not cause an alert in a signature-based NIDS. By “anomaly-based” NIDS, we mean a NIDS that looks at the sequences of commands to find sequences that do not look right, without looking at the data itself. By “signature-based” NIDS, we mean a NIDS that looks at the data itself. (If we are to generate valid traffic from the models, the traffic must include sequences that would be considered normal by the NIDS and would also have data within the sequences that would be considered normal by the NIDS.)

Two factors that affect the learning of the sequential models that represent the protocol usage are: How to identify the underlying stochastic processes in the data, and what tradeoff to strike between accuracy and reliability. Accuracy is increased when the model digs more deeply into the past history of the modeled system. Reliability is increased when the amount of training data providing the basis for the model is increased. That is, a given volume of training data may represent a relatively large number of sequences that are short, e.g. consisting of only two commands, and thus have little history. Alternatively, the same volume of data may represent a smaller number of sequences that are relatively long, e.g. consisting of sequences of three or four commands. In the second case, although there is more history, the probability estimates of the various sequences will be less accurate because there are fewer examples of each sequence to be counted.

Once the underlying processes are identified and the tradeoff between accuracy and reliability is determined, machine learning methods can be used to build these models automatically, using a computer, from data collected behind a NIDS. The subsequent models capture actual usage patterns both from the set of all possible usages specified in the protocol as well as usages not specified in the protocol.

### Identifying Underlying Processes

Typical networking software and applications are multi-threaded, interacting with multiple systems or users simultaneously. A dataset of protocol traffic intersperses these interactions. Although it might be convenient to aggregate these multiple interactions into a single sequential model that represents recent protocol usage, it is feasible to do so only if it is understood how messages within the data stream relate, to each other.

Instead of building a single model to capture complex protocol traffic, it may be advantageous to consider two or more interdependent sequential models. For example, the above-referenced work on building sequential models from web logs the authors identified two interacting processes interspersed in the data stream. The first process comprises the possible sequences of URLs that are visited as a user navigates a web application. This process was represented by the control model. The second process comprises the possible sets of parameter values that are sent as name-value pairs in a request for any specific URL, such as when a user enters data in a form. This process was represented by the data model.

For pedagogical purposes, it is useful to refer to the well-known SMTP protocol for a further example of the distinction between the control model and the data model. In regard to SMTP, the control model is the sequence of SMTP commands. The data model is identified with the parameters used in each command. For example, the control model specifies that RCPT TO may follow MAIL FROM (or equivalently, that the state RCPT_OK may follow the state MAIL_OK). The data model specifies that a valid email address must be provided as a parameter to the MAIL FROM command. Furthermore, a data model with more history might specify that the domain of the email address (i.e. ALICE.COM) must be the same as the domain provided as a parameter in an earlier HELO command.

### Trading Off Accuracy for Reliability

Sequential models can be used to compactly represent a probability distribution over all possible sequences of messages in the recent usage of a protocol. In general, the conditional probability of the next message may depend on the history of all previous messages. A common statistical learning technique is to build compact models by trading off accuracy for reliability. We do so by making use of the statistical chain rule and the statistical assumption of conditional independence (i.e., the Markov assumption) that messages far enough in the past do not affect the probability of the next message, if we know a subset of recent messages.

For convenience, it is noted here that one statement of the statistical chain rule is:

P(A₁ [symbol] A₂ [symbol] . . . [symbol] Aₙ)=P(A₁)*P(A₂|A₁)*P(A₃|A₂ [symbol] A₁)* . . . *P(Aₙ|Aₙ₋₁ [symbol] Aₙ₋₂ [symbol] . . . and A₁),

where P(x) means “the probability of x” and P(x [symbol] y) means “the joint probability of x and y”.

The accuracy of the approximation depends on how much information is lost by ignoring some history. Variants include the 1-Markov (bigram) assumption in which only the previous message is needed to estimate the probability of the next message, and the 2-Markov (trigram) assumption in which the previous two messages help estimate the probability of the next message.

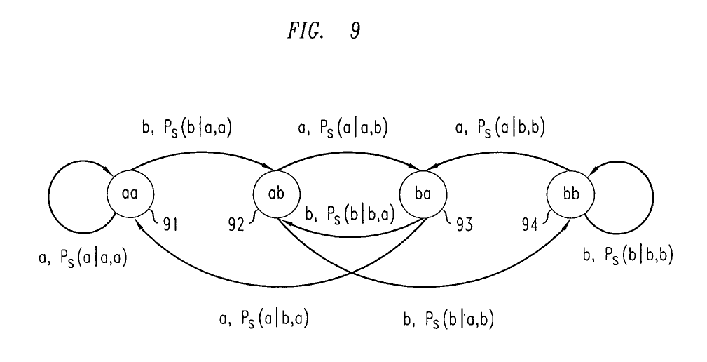

A 2-Markov model is depicted in FIG. 9. In this figure each of nodes 91-94 represents the previous two messages seen. Each transition out of a node depicts a possible next message and the probability of seeing that message given the previous two messages. Thus, for example, on the edge from node 91 to node 93, a is the next output symbol, a also being the current output symbol, and b the previous output symbol. Pₛ(x) is the probability of the next output symbol being x. Pₛ(a|b,a) is the conditional probability that the next output symbol is a, given that the previous two output symbols are b followed by a.

### Generating Test Sequences

The learned sequential models of protocol usage are used to find untested message sequences that may reveal unpatched software vulnerabilities. Finding untested inputs by fuzzing, i.e., by brute-force random probing, has a low probability of finding vulnerabilities in complex software. It is more efficient to use specially constructed queries. In the lab, the learned sequential models are then queried, e.g. using a computer, to find test cases that have a higher probability of revealing vulnerabilities. These queries may look for unlikely but legal sequences of messages or messages that contain inputs from a class of previously vulnerable inputs.

A stochastic sequential model can be used to assign an approximate probability to any sequence of messages. Query algorithms can be formulated that use such models to build a variety of test cases to test target software implementations. For example, we believe that algorithms for performing queries similar in structure to any of those below can readily be obtained or constructed by those skilled in the art:
Find k message sequences randomly, according to a distribution represented in the captured traffic.
Find the k most likely message sequences.
Find the k least likely message sequences.
Find k message sequences that include message R6.
Find unlikely message sequences in which message R6 follows message R94.
Find unlikely message sequences in which message R6 follows message R18, R27, R94 (in order).

A query may seed the sequence with steps needed for a type of attack and query whether or not any full sequences exist that include those steps. A test case might be composed by querying the sequential model for a message sequence constructed by concatenating two highly likely message sequences that could possibly follow each other but have not yet been observed in sequence. (The resulting low probability but legal sequence may have been overlooked during software testing.) Directed probing in the lab using these test cases is more likely than fuzzing to find exploitable vulnerabilities in complex software.

As a result of appropriately constructed queries, packet sequences may be devised whose use in an attack varies depending upon responses received from the protected network, i.e., from the network that lies behind the defensive device.

What is claimed is:

1. A method, comprising:
intercepting packets that pass through a defensive device;
reading, from the intercepted packets, protocol sequences that pertain to at least one protocol or network application; and
constructing, using a computer, at least one stochastic sequential model of usage of the protocol or network application from the protocol sequences.

2. The method of claim 1, further comprising:
using the stochastic sequential usage model to provide one or more protocol sequences that will pass through the defensive device.

3. The method of claim 2, wherein the one or more protocol sequences are provided in response to a query that specifies probabilities for protocol sequences or portions thereof.

4. The method of claim 2, wherein the one or more protocol sequences are provided in response to a query that specifies sub-sequences of the protocol sequences.

5. The method of claim 2, further comprising transmitting packets through a defensive device into a network protected by the defensive device, wherein:
the stochastic sequential usage model is applicable to the defensive device that protects the network; and
the transmitted packets include at least part of one or more of the provided protocol sequences.

6. The method of claim 5, further comprising:
monitoring the protected network to detect whether the transmitted packets induce a security incident.

7. The method of claim 6, further comprising:
identifying one or more security incidents induced by the transmitted packets; and
modifying the defensive device protecting the network to recognize one or more sequences of the transmitted packets that have been identified as inducing security incidents.

8. The method of claim 5, further comprising:
selecting among the provided protocol sequences;
wherein the transmitted packets include at least part of one or more selected sequences; and
wherein the selecting step is dependent on responses sent by the protected network.
